(19) United States
(12) Patent Application Publication
(10) Pub. No.: US 2014/0281095 A1
(43) Pub. Date: Sep. 18, 2014

(54) COMPUTING DEVICE AND METHOD FOR INTEGRATING THUNDERBOLT CHIP ON MOTHERBOARD

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: HUNG-CHI HUANG, New Taipei (TW); PO-YEN PAN, New Taipei (TW)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 14/108,397

(22) Filed: Dec. 17, 2013

(30) Foreign Application Priority Data
Mar. 15, 2013 (TW) 102109190

(51) Int. Cl. G06F 13/40

(52) U.S. Cl. CPC G06F 13/409
USPC 710/301

(57) ABSTRACT

In a method for integrating a thunderbolt (TBT) chip on a motherboard of a computing device, the motherboard includes a PCIe slot, and a platform controller hub (PCH) chip. The computing device includes a PCIe card plugged into the PCIe slot. The PCIe card includes a micro controller unit (MCU), and an EEPROM. The TBT chip, the MCU, and the EEPROM are integrated into the PCIe card. The PCH chip communicates with the TBT chip and the MCU through a system management bus of the motherboard. The method defines a TBT protocol parameter list used in the TBT chip, and sets GPIO parameters to support the TBT chip to perform various TBT protocol functions according to the TBT protocol parameter list. The TBT chip executes a TBT protocol function according to a GPIO signal output from the MCU.

### BACKGROUND

1. Technical Field

Embodiments of the present disclosure relate to input/output (I/O) ports integrating systems and methods, and particularly to a computing device and method for integrating a thunderbolt (TBT) chip on a motherboard of the computing device.

2. Description of Related Art

Thunderbolt (TBT) chip is a super I/O port having a high rate of data transmission, a high compatibility with peripheral component interconnect express (PCIe) devices, and a high resolution display capability. FIG. 1 is a prior art of a TBT chip 111 which is integrated in an external card 110. The external card 110 can be plugged into a PCIe slot 121 of a motherboard 120. The external card 110 includes two ports (i.e., port_{—}1 and port_{—}2) and a general purpose input-output (GPIO) port. For the TBT chip 111 to perform all functions completely, at least two cable lines (e.g., cable_{—}1 and cable_{—}2) need to be used to connect the TBT chip 111 to the motherboard 120, and then the TBT chip 111 can communicate with a platform controller hub (PCH) chip 122 of the motherboard 120 through the two cable lines. Thus, the TBT chip 111 designed on the motherboard 120 needs additional hardware configuration and cable lines. Therefore, there is room for improvement in the art.

### BRIEF DESCRIPTION OF THE DRAWINGS

FIG. 1 is a diagram illustrating prior art of a TBT chip integrated in an external card.

FIG. 2 is a block diagram of one embodiment of a computing device including a TBT chip integration system.

FIG. 3 is a flowchart of one embodiment of a method for integrating a TBT chip on a motherboard of the computing device.

FIG. 4 is a illustrates one embodiment of defining a TBT protocol parameter list used in the TBT chip.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium include CDs, DVDs, flash memory, and hard disk drives.

FIG. 2 is a block diagram of one embodiment of a computing device 100 including a thunderbolt (TBT) chip integration system 20. In the embodiment, the computing device 1 may further include, but is not limited to, a PCI express (PCIe) card 1 and a motherboard 2. The PCIe card 1 is integrated with a TBT chip 10, a micro controller unit (MCU) 11, and an electrically-erasable programmable read-only memory (EEPROM) 12. The motherboard 2 is integrated with a PCIe slot 21, a platform controller hub (PCH) chip 22, a basic input-output system (BIOS) 23, a storage device 24, and at least one processor 25. The PCH chip 22 connects to the PCIe slot 21 through a system management bus (SMbus) 26. The PCH chip 22 can communicate with the BIOS 23 and the processor 25 through the SMbus 26. In one embodiment, the computing device 100 may be a personal computer, a server computer, a workstation computer, or other data processing device.

In the embodiment, the TBT chip 10 is a super I/O port having various TBT protocol functions, such as a high rate of data transmission, a high compatibility with PCIe devices, and a high resolution display capability. The PCIe card 1 can be plugged into the PCIe slot 21 of the motherboard 2. The PCIe card 1 has two external ports named port_{—}1 and port_{—}2 for external peripheral devices including network cards, audio cards, video cards, monitors and external hard-disk drives.

In one embodiment, the storage device 24 may be an internal storage system, such as a random access memory (RAM) for temporary storage of information, and/or a read only memory (ROM) for permanent storage of information. The storage device 24 may also be an external storage system, such as an external hard disk, a storage card, or a data storage medium. The at least one processor 25 is a central processing unit (CPU), a microprocessor, or data processor that performs various functions of the computing device 100.

In one embodiment, the TBT chip integration system 20 may include a setting module 201, an integration module 202, and a control module 203. The modules 201-203 may comprise computerized instructions in the form of one or more computer-readable programs that are stored in a non-transitory computer-readable medium (such as the storage device 24) and executed by the at least one processor 25. A description of each module is given in the following paragraphs.

FIG. 3 is a flowchart of one embodiment of a method for integrating a TBT chip on a motherboard of a computing device. In the first embodiment, the method can integrate the TBT chip 10 into the PCIe card 1 that can be plugged into the motherboard 2, update parameters of each pin of the MCU 11 to output GPIO signals, and control the TBT chip 10 to perform various TBT protocol functions according to the GPIO signals. Depending on the embodiment, additional steps may be added, others removed, and the ordering of the steps may be changed.

In step S31, the setting module 201 defines a TBT protocol parameter list used in the TBT chip 10, and stores the TBT protocol parameter list in the EEPROM 12. In one embodiment, the TBT protocol parameter list defines signal parameters of pins of the MCU 11 which operates in different working modes. Referring to FIG. 4, if the the MCU 11 operates in a normal mode, the signal parameters of pins Sim-pin3, Sim-pin 6 and Sim-pin 7 of the MCU 11 is respectively defined as logical values “0,” “1” and “1”. If the the MCU 11 operates in a TBT debug mode, the signal parameters of pins Sim-pin3, Sim-pin 6 and Sim-pin 7 of the MCU 11 are defined as logical value “1”.

In step S32, the setting module 201 sets general purpose input-output (GPIO) parameters of the MCU 11 to support the TBT chip 10 to perform various TBT protocol functions according to the TBT protocol parameter list through the BIOS 23. In the embodiment, the TBT protocol functions may include a high rate of data transmission, a high compatibility with PCIe devices, and a high resolution display capability. The GPIO parameters can include a data transmission parameter for supporting the high rate of data transmission, a hardware configuration for supporting the high compatibility with PCIe devices, and a display parameter for supporting the high resolution display capability.

In step S33, the manufacturer integrates the TBT chip 10, the MCU 11, and the EEPROM 12 into the PCIe card 1, and plugs the PCIe card 1 into the PCIe slot 21 of the motherboard 2. Referring to FIG. 2, the TBT chip 10, the MCU 11 and the EEPROM 12 are integrated into the PCIe card 1, and the PCIe card 1 can be plugged into the PCIe slot 21 of the motherboard 2.

In step S34, the integration module 202 establishes a communication between the MCU 11 and the PCH chip 22 through the system management bus 26 of the motherboard 2 when the PCIe card 1 is plugged into the PCIe slot 21 of the motherboard 2. In the embodiment, the PCH chip 22 can communicate with the MCU 11 through the system management bus 26 when the PCIe card 1 is plugged into the PCIe slot 21 of the motherboard 2.

In step S35, the integration module 202 establishes a relationship between each pin of the MCU 11 and the TBT chip 10 to perform the TBT protocol functions according to the GPIO parameters. In the embodiment, the TBT chip 10 is initialized to perform the TBT protocol functions according to the relationship.

In step S36, the control module 203 controls the MCU 11 to output a GPIO signal when an external peripheral device is connected to the PCIe card 1, and controls the TBT chip 10 to execute a TBT protocol function according to the GPIO signal. In the embodiment, the external peripheral device can be a network card, an audio card, a video card, a monitor or a hard-disk drive. For example, if one of the ports (e.g., port_{—}1) of the PCIe card 1 is connected to a network card, the MCU 11 outputs a network transmission signal to control the TBT chip 10 to execute the high rate of data transmission for the network card. If one of the ports (e.g., port_{—}2) of the PCIe card 1 is connected to a monitor, the MCU 11 outputs a display signal to control the TBT chip 10 to execute a high display resolution for the monitor.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a motherboard comprising a peripheral component interconnect express (PCIe) slot, a platform controller hub (PCH) chip, a system management bus, and at least one processor;
a PCIe card plugged into the PCIe slot of the motherboard, and the PCIe card comprising a thunderbolt (TBT) chip, a micro controller unit (MCU), and an electrically-erasable programmable read-only memory (EEPROM); and
a storage device storing a computer-readable program including instructions that, when executed by the at least one processor, causes the at least one processor to:
define a TBT protocol parameter list used in the TBT chip, and store the TBT protocol parameter list in the EEPROM;
set general purpose input-output (GPIO) parameters of the MCU to support the TBT chip to perform various TBT protocol functions according to the TBT protocol parameter list;
establish a communication between the MCU and the PCH chip through the system management bus when the PCIe card is plugged into the PCIe slot of the motherboard;
establish a relationship between each pin of the MCU and the TBT chip to perform the TBT protocol functions according to the GPIO parameters; and
control the MCU to output a GPIO signal when an external peripheral device is connected to a port of the PCIe card, and control the TBT chip to execute a TBT protocol function according to the GPIO signal.

2. The computing device according to claim 1, wherein the TBT chip is a super I/O port that performs the TBT protocol functions.

3. The computing device according to claim 1, wherein the TBT protocol functions comprise a high rate of data transmission, a high compatibility with PCIe devices, and a high resolution display capability.

4. The computing device according to claim 3, wherein the GPIO parameters comprise a data transmission parameter for supporting the high rate of data transmission, a hardware configuration for supporting the high compatibility with PCIe devices, and a display parameter for supporting the high resolution display capability.

5. The computing device according to claim 1, wherein the TBT protocol parameter list defines signal parameters of pins of the MCU which operates in different working modes.

6. The computing device according to claim 1, wherein the external peripheral device is a network card, an audio card, a video card, a monitor or a hard-disk drive.

7. A method for integrating a thunderbolt (TBT) chip on a motherboard of a computing device, the motherboard comprising a peripheral component interconnect express (PCIe) slot and a platform controller hub (PCH) chip, the method comprising:
defining a TBT protocol parameter list used in the TBT chip, and storing the TBT protocol parameter list in an electrically-erasable programmable read-only memory (EEPROM);
setting general purpose input-output (GPIO) parameters of a micro controller unit (MCU) to support the TBT chip to perform various TBT protocol functions according to the TBT protocol parameter list;
integrating the MCU, the EEPROM, and the TBT chip into a PCIe card;
establishing a communication between the MCU and the PCH chip through a system management bus of the motherboard when the PCIe card is plugged into a PCIe slot of the motherboard;
establishing a relationship between each pin of the MCU and the TBT chip to perform the TBT protocol functions according to the GPIO parameters; and
controlling the MCU to output a GPIO signal when an external peripheral device is connected to a port of the PCIe card, and controlling the TBT chip to execute a TBT protocol function according to the GPIO signal.

8. The method according to claim 7, wherein the TBT chip is a super I/O port that performs the TBT protocol functions.

9. The method according to claim 7, wherein the TBT protocol functions comprise a high rate of data transmission, a high compatibility with PCIe devices, and a high resolution display capability.

10. The method according to claim 9, wherein the GPIO parameters comprise a data transmission parameter for supporting the high rate of data transmission, a hardware configuration for supporting the high compatibility with PCIe devices, and a display parameter for supporting the high resolution display capability.

11. The method according to claim 7, wherein the TBT protocol parameter list defines signal parameters of pins of the MCU which operates in different working modes.

12. The method according to claim 7, wherein the external peripheral device is a network card, an audio card, a video card, a monitor or a hard-disk drive.

13. A non-transitory storage medium having stored thereon instructions that, when executed by at least one processor of a computing device, cause the processor to perform a method for integrating a thunderbolt (TBT) chip on a motherboard of the computing device, the motherboard comprising a peripheral component interconnect express (PCIe) slot and a platform controller hub (PCH) chip, the method comprising:
defining a TBT protocol parameter list used in the TBT chip, and storing the TBT protocol parameter list in an electrically-erasable programmable read-only memory (EEPROM);
setting general purpose input-output (GPIO) parameters of a micro controller unit (MCU) to support the TBT chip to perform various TBT protocol functions according to the TBT protocol parameter list;
integrating the MCU, the EEPROM, and the TBT chip into a PCIe card;
establishing a communication between the MCU and the PCH chip through a system management bus of the motherboard when the PCIe card is plugged into a PCIe slot of the motherboard;
establishing a relationship between each pin of the MCU and the TBT chip to perform the TBT protocol functions according to the GPIO parameters; and
controlling the MCU to output a GPIO signal when an external peripheral device is connected to a port of the PCIe card, and controlling the TBT chip to execute a TBT protocol function according to the GPIO signal.

14. The non-transitory storage medium according to claim 13, wherein the TBT chip is a super I/O port that performs the TBT protocol functions.

15. The non-transitory storage medium according to claim 13, wherein the TBT protocol functions comprise a high rate of data transmission, a high compatibility with PCIe devices, and a high resolution display capability.

16. The non-transitory storage medium according to claim 15, wherein the GPIO parameters comprise a data transmission parameter for supporting the high rate of data transmission, a hardware configuration for supporting the high compatibility with PCIe devices, and a display parameter for supporting the high resolution display capability.

17. The non-transitory storage medium according to claim 13, wherein the TBT protocol parameter list defines signal parameters of pins of the MCU which operates in different working modes.

18. The non-transitory storage medium according to claim 13, wherein the external peripheral device is a network card, an audio card, a video card, a monitor or a hard-disk drive.
